(19) United States
(12) Patent Application Publication
(10) Pub. No.: US 2010/0131719 A1
(43) Pub. Date: May 27, 2010

(54) Early Response Indication for data retrieval in a multi-processor computing system

(76) Inventors: Mark D. Luba, Plymouth Meeting, PA (US); Gary J. Lucas, Pine Springs, MN (US); Kelvin S. Vartti, Hugo, MN (US)

Correspondence Address: UNISYS CORPORATION, Unisys Way, Mail Station E8-114, Blue Bell, PA, 19424, US

(21) Appl. No.: 12/694,652

(22) Filed: Jan. 27, 2010

Related U.S. Application Data
(62) Division of application No. 12/004,659, filed on Dec. 21, 2007.

(51) Int. Cl. G06F 12/00; G06F 12/08; G06F 13/36

(52) U.S. Cl. 711/146; 710/113; 711/E12.001; 711/E12.033

(57) ABSTRACT

A data processing system is described that reduces read latency of requested memory data, thereby resulting in improved system performance. An exemplary system includes a bus, a processor, and a controller associated with the processor. The controller is configured to send a request for data to a memory storage unit, receive, from the memory storage unit, an early response indicating that the controller will later receive the requested data, and upon receipt of the early response indicator, start a timer to wait a period of time. The controller is further configured to, after expiration of the timer but prior to receipt of the requested data, send an arbitration request to initiate a transaction on the bus to communicate the requested data from the controller to the processor when the requested data is later received by the controller.

### TECHNICAL FIELD

This application relates to data retrieval within a data processing system.

### BACKGROUND

In multiple processor computing systems, various components, such as processing modules and memory storage units, are interconnected by one or more busses. In such systems, a given processing module may be coupled to one or more memory storage units, and a given memory storage unit may be coupled to one or more processing modules. In many instances, a processing module will include a processor and a system controller, while a memory storage unit will include a memory controller and one or more memory units or modules.

A processing module may, over the course of time, need to read or write data for processing within the system. For example, when a processor within a processing module needs to read data, it may first check to see if such data is available from its local cache. If the data is not available in its cache, the processor may request that the processing module request such data to be retrieved from a memory storage unit that contains the requested data. In this case, the system controller sends, in a request transaction, a read request to the memory controller of the memory storage unit that contains the data. Upon receipt of the read request, the memory controller obtains the requested data from an appropriate memory unit, and provides this data, in a response transaction, back to the requesting system controller.

Once the requesting system controller receives the data, it typically must arbitrate to gain control of the system bus that couples the system controller with the processor. Arbitration can be time consuming. In many instances, arbitration and subsequent phases of the bus may require multiple bus cycles before the response data can be driven by the system controller onto the bus, during which time the system controller may need to buffer the data in a temporary storage space. In general, memory read-access latency, which relates to the amount of time required to access data from memory within a memory storage unit, can be a contributor to overall latency and system performance degradation.

### SUMMARY

In general, the invention is directed to a data processing system that reduces read latency of requested memory data, thereby resulting in improved system performance. The system incorporates at least one memory storage unit having a memory controller that, upon receiving a request for data from a system controller, is capable of sending two responses back to the system controller at different points in time. The first response is an “early response,” and the second, subsequent response is a data response that contains the requested data. The early response is an early indicator to the system controller that the requested data is present within the memory storage unit and will be arriving at an approximately fixed later time by a subsequent data response. The system controller processes this early response and uses the time the early response was received as a basis for determining timing as to when to initiate arbitration of the processor bus and also subsequent phases on the bus in anticipation of the requested data arriving at a later time. When the requested data finally arrives, the system controller and the bus are then already in a state in which the system controller can stream the received data directly onto the bus without having to wait for arbitration and bus transaction cycles to complete. As a result, a positive predictable indication of forthcoming response data (early response) may be implemented, in conjunction with a programmable timer in certain cases, to effectively hide processor bus cycles and realize latency reduction, thus improving system performance.

In one embodiment, a method includes sending a request for data from a controller, such as a system controller, to a memory storage unit (the controller being associated with a processor), receiving, by the controller, an early response from the memory storage unit indicating that the controller will later receive the requested data, and upon receipt of the early response indicator, starting a timer with the controller to wait a period of time. The method further includes, after expiration of the timer but prior to receipt of the requested data, sending an arbitration request from the controller to initiate a transaction on a bus to communicate the requested data from the controller to the processor when the requested data is later received by the controller.

In one embodiment, a data processing system includes a bus, a processor, and a controller, such as a system controller, that is associated with the processor. The controller is configured to send a request for data to a memory storage unit. The controller is configured to receive, from the memory storage unit, an early response indicating that the controller will later receive the requested data, and upon receipt of the early response indicator, start a timer to wait a period of time. The controller is further configured to, after expiration of the timer but prior to receipt of the requested data, send an arbitration request to initiate a transaction on the bus to communicate the requested data from the controller to the processor when the requested data is later received by the controller.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a block diagram illustrating a data processing system having multiple processing modules and memory storage units, according to one embodiment.

FIG. 1B is a block diagram illustrating a data processing system having a first processing module, a memory storage unit, and a second processing module comprising a snooped node, according to one embodiment.

FIG. 2A is a block diagram illustrating additional details of a processing module, according to one embodiment.

FIG. 2B is a block diagram illustrating additional details of the system controller shown in FIG. 2A, according to one embodiment.

FIG. 3A is a block diagram illustrating additional details of a memory storage unit, according to one embodiment.

FIG. 3B is a block diagram illustrating additional details of the memory controller shown in FIG. 3A, according to one embodiment.

FIG. 4 is a flow diagram illustrating the processing of a read request sent by a system controller to a memory controller, wherein the memory controller provides an early response to the system controller, according to one embodiment.

FIG. 5A-5E are flow diagrams illustrating various embodiments of the processing of read requests sent by a system controller to a memory controller, wherein the memory controller additionally sends a snoop command to a snooped system controller.

### DETAILED DESCRIPTION

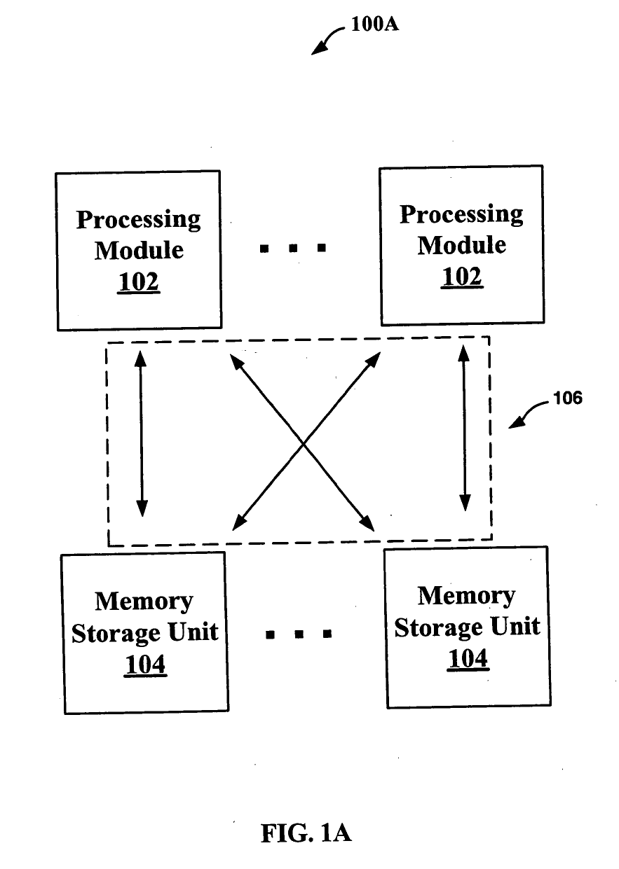

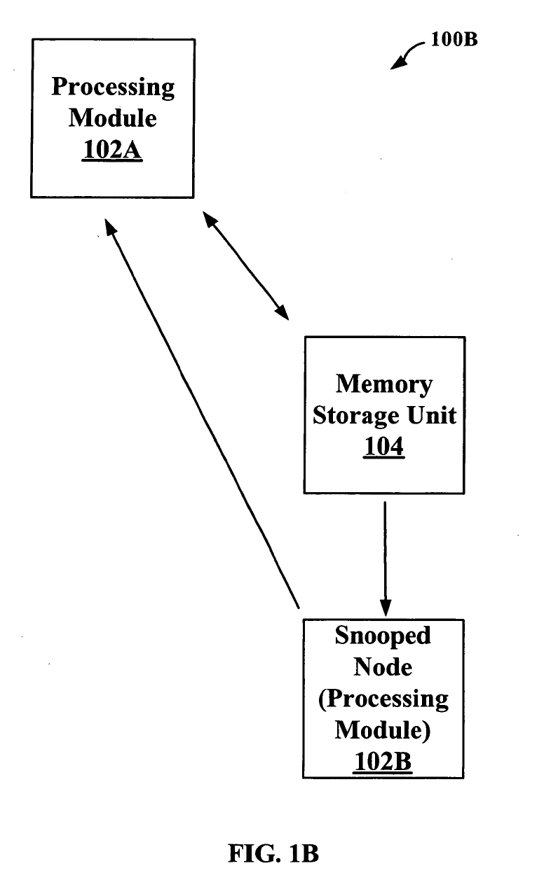

FIG. 1A is a block diagram illustrating an example data processing system 100A that has one or more processing modules 102 and one or more memory storage units 104, according to one embodiment. Data processing system 100A is shown in a simplified form, and generally represents any multi-processor computing system in which processing modules 102 utilize memory storage units 104 to store program code and/or data. Example computing systems include enterprise servers and mainframes commercially available from Unisys Corporation.

During execution, in system 100A, data flows between multiple processing modules 102 and multiple memory storage units 104 via one or more busses and/or interfaces, generally represented as system interconnect 106 in FIG. 1. Each processing module 102 may, for example, access any individual memory storage unit 104 via system interconnect 106, as is shown in FIG. 1A. In one embodiment, system interconnect 106 comprises an interface bus that may comprise a uni-directional control bus, a bi-directional request bus, and a bi-directional data bus.

In operation, a processing module 102 sends requests to memory storage units 104 to manipulate or use data. For example, a processing module 102 may issue read requests to retrieve data from memory storage units 104, and may also issue write requests to write data into a memory storage unit. Data movements and other communications between processing modules 102 and memory storage unit 104 may be referred to herein as “transactions.” Any number of processing modules 102 and memory storage units 104 may be included within the system 100A.

The data processing system 100A shown in FIG. 1 A may be utilized to help reduce read latency of requested memory data from one or more of the memory storage units 104, thereby resulting in improved system performance. An individual memory storage unit 104 may have a memory controller that, upon receiving a request for data from a system controller associated with a processing module 102, is capable of sending two separate responses back to the system controller at different points in time. The first response is an “early response,” and the second, subsequent response is a data response that contains the requested data. The early response is an early indicator to the system controller of the processing module 102 that the requested data will be arriving at a later time in a subsequent data response.

The system controller of the processing module 102 may use the early response as a basis for determining timing as to when to initiate arbitration of the processor bus and subsequent phases on the bus in anticipation of the requested data arriving at a later time. When the requested data finally arrives from the memory controller of the memory storage unit 104, the system controller and the bus are then already in a state in which the system controller can stream the received data directly onto the bus without having to wait for arbitration and bus transaction cycles to complete. As a result, a positive predictable indication of forthcoming response data (such as the early response) may be implemented, in conjunction with a programmable timer in certain cases, to effectively hide processor bus cycles and realize latency reduction, thus improving system performance of the system 100A.

FIG. 1B is a block diagram illustrating a data processing system 100B having a first exemplary processing module 102A, a memory storage unit 104, and a second exemplary processing module 102B comprising a snooped node, according to one embodiment. Data processing system 100B of FIG. 1B may be viewed as generally illustrating a portion of data processing system 100A of FIG. 1A. More specifically, FIG. 1B serves to illustrate techniques used by data processing system 100B in ensuring data coherency.

In the example of FIG. 1B, the processing module 102B acts as a snooped node, which is capable, in general, of receiving activity (i.e., transactions) that request updated data (snoop) within system interconnect 106 (FIG. 1). While the memory storage unit 104 maintains data in its local storage, the snooped node 102B may maintain a copy of certain data in its own local storage space, such as a cache. In certain instances, the snooped node 102B may maintain a version of data that is more up-to-date, or current, than the version of the corresponding data maintained by the memory storage unit 104. For example, the snooped node 102B may internally have updated its version of the data in its local cache. In this case, in one embodiment, the snooped node 102B may respond to a snoop request from the memory storage unit 104 by sending updated data to the requesting processing module 102A In one embodiment, if the processing module 102A needs to obtain certain data, it may first determine whether it has a local copy of the needed data within its own local storage area, such as a cache. If so, the processing module 102A will read this data from its local storage area. If, for example, the data is in a cache, it may be retrieved in short order. If, however, the processing module 102A does not have a local copy of the needed data, it may send a read request to the memory storage unit 104 to retrieve the data. The memory storage unit 104, upon receipt of this read request, typically obtains a copy of the requested data from its memory and sends the data back to the requesting processing module 102A.

However, if the memory storage unit 104 determines that the snooped node 102B has gained control of the requested data (i.e., may have a more up-to-date copy of the data), it will send a snoop request, or command, to the snooped node 102B. In this case, the snooped node 102B will check its local storage area, such as its local cache, to determine if it may have a more current, or updated, version of the data than that contained by the memory storage unit 104. If it does, it may, in one embodiment, directly provide this data (snoop response) to the processing module 102A. In one embodiment, the snooped node 102B returns the snoop response to the processing module 102A. In one embodiment, the memory storage unit 104 will also return the read data back to the processing module 102A, in case the snooped node 102B may not have the current copy of the data.

In one embodiment, a memory controller of the memory storage unit 104, as described earlier, is capable of sending an early response back to a system controller of the requesting processing module 102, such as the module 102A shown in FIG. 1B. However, when a processing module 102, such as the module 102B, is being snooped within the system 100B, the snooped module 102B is also capable of sending an early response back to the system controller of the requesting module 102A. The module 102B may send this early response after it has received a snoop command from the memory controller of the memory storage unit 104. The system controller of the requesting module 102A may use this early response as a basis in determining when to initiate arbitration of the processor bus and subsequent phases on the bus in anticipation of the requested data arriving at a later time from the module 102B. As a result, a positive predictable indication (such as the early response) of forthcoming response data may be implemented, in conjunction with a programmable timer in certain cases, to effectively hide processor bus cycles and realize latency reduction, thus improving system performance of the system 100B.

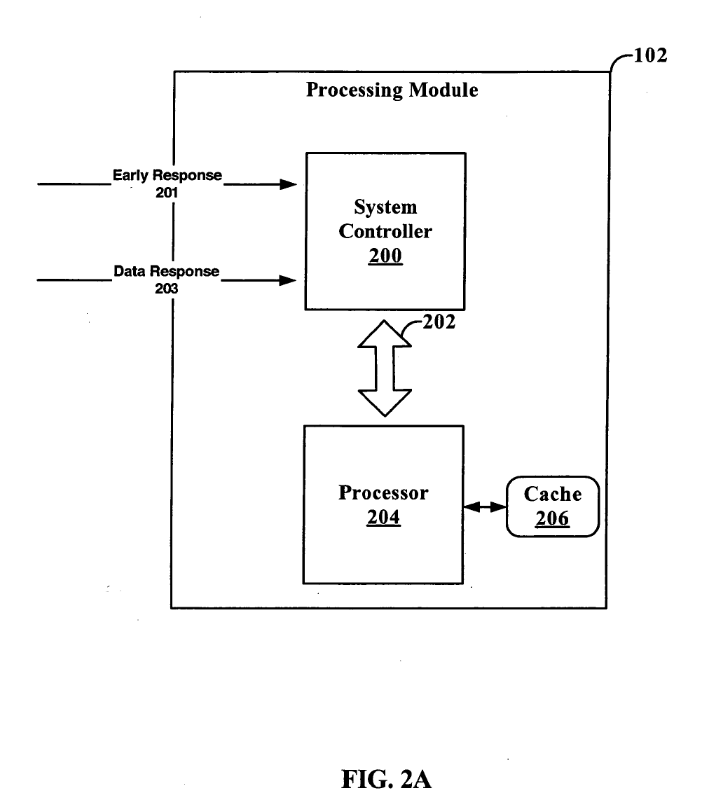

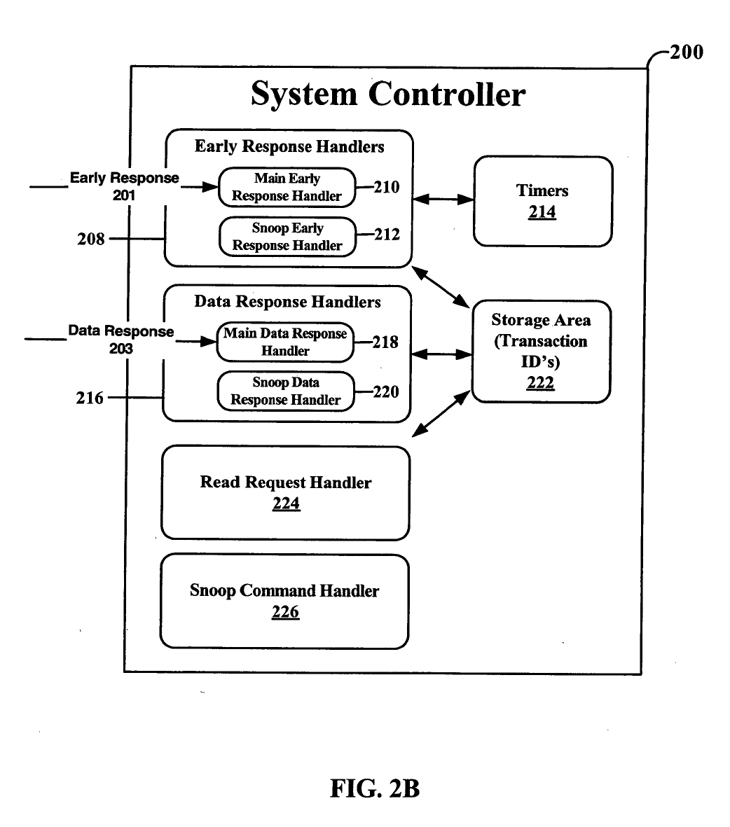

FIG. 2A is a block diagram illustrating additional details of an exemplary processing module 102, according to one embodiment. In this example, the processing module 102 includes a system controller 200 and a microprocessor 204. The system controller 200 is coupled to the processor 204 via a processor bus 202. In one embodiment, the processor bus 202 may be referred to as a front-side bus. The processor 204 sends commands or requests across the bus 202 to the system controller 200. For example, the processor 204 may issue a read request to the system controller 200 to read data from an external memory storage unit 104, or may issue a write request to the system controller 200 to write data into the external memory storage unit.

The processor 204 is also coupled to a processor cache 206. The cache 206 provides one or more high-speed storage areas to store commands and data (e.g., an instruction cache and a data cache) for use by the processor 204. In certain instances, the processor 204 is capable of obtaining needed data directly from the cache 206. In these instances, the processor 204 need not issue requests to the system controller 200 to read data from an external memory storage unit 104.

As shown in FIG. 2A, the system controller 200 of the processing module 102 is capable of receiving and processing early responses, such as the early response 201 shown in FIG. 2A. As noted previously, a memory controller of a memory storage unit 104 sends an early response, in one embodiment, as a positive indication of forthcoming data. The system controller 200 may use the early response 201 as a basis for determining when to initiate arbitration and subsequent phases on the bus in anticipation of the data arriving at a later time in a data response 203 (which is sent from the memory controller of the memory storage unit 104). Once the system controller 200 receives the data response 203, it is capable of immediately streaming the data onto the bus 202. In one embodiment, the system controller 200 receives both an early response and a data response from a snooped node (such as the processing module 102B shown in FIG. 1B).

FIG. 2B is a block diagram illustrating a portion of the system controller 200 shown in FIG. 2A, according to one embodiment. In this embodiment, the system controller 200 includes various functional units and information that is used by the functional units. As shown in FIG. 2B, the example system controller 200 includes at the following functional units: a set of early response handlers 208, a set of data response handlers 216, a read request handler 224, and a snoop command handler 226. As also shown, a timer 214 contains information about timers that are used by the early response handlers 208. A storage area 222 contains information about transaction identifiers (ID's) that are used by the early response handlers 208, the data response handlers 216, the read request handler 224, and the snoop command handler 226.

When the processor 204 needs data from an external memory storage unit 104, it sends a read request to the system controller 200 via the bus 202, according to one embodiment. The read request handler 224 handles this request from the processor. This request is a transaction, according to one embodiment. In this embodiment, every message, or command, that is sent by one entity to another comprises a transaction. For example, the system 100A may process the following types of transactions: read requests, read responses, write requests, write response, and others. Each transaction may, in one embodiment, comprise a multi-bit message that includes one or more of the following fields: a header (indicating whether the transaction includes control information or data information), an operational code (opcode), an identifier, an address, and data. In one embodiment, the opcode of the transaction specifies whether the transaction is, for example, a read request, a write request, a read response, or a write response. In one embodiment, in which early response transactions are used, the opcode may specify that the transaction is an early response (such as one delivered from a memory storage unit 104 or a snooped node 102B).

Each transaction may have a unique identifier that is specified in the identifier field. When the read request handler 224 receives a read request transaction from the processor 204, it may save the identifier of the transaction in the transaction ID storage area 222 for later use. When the system controller 200 later provides the requested data back to the processor 204 in a subsequent transaction, it can then retrieve the corresponding identifier from the storage area 222 and include it within the transaction, so that the processor 204 can match the response with its earlier request.

The read request handler 224 is also capable of storing within the storage area 222 a transaction ID of the new transaction that it sends to the memory storage unit 104, and further associating this transaction ID with the transaction ID of the request it received from the processor 204. By doing so, the early response handlers 208 and data response handlers 216 may access the storage area 222 when processing incoming transactions. Upon receipt of an incoming transaction, the handlers 208 or 216 may extract the transaction ID and cross reference it with the ID's stored in the storage area 222. In the case of incoming data, the data response handlers 216 may associate the ID of the incoming data transaction and identify the ID of the original read request from the processor 204, which had been previously extracted and stored in the storage area 222. The data response handlers 216 can then include the ID of the original read request within the data response transaction that is provided back to the processor 204.

Returning to discussion of the incoming read request, the read request handler 224 is further responsible for sending a read request to the appropriate memory storage unit 104 after it has received the request from the processor 204. The read request handler 224 is capable of identifying the appropriate memory storage unit 104 based upon the information in the address field that is provided within the read request transaction sent by the processor 204.

As will be described in more detail below, the memory storage unit 104 that has received the read request from the system controller 200 is capable of, according to one embodiment, sending an early response indicator back to the system controller 200. Such an early response indicates to the system controller 200 that the memory storage unit 104 is processing the read request and has determined that it will be providing the requested data at a relatively fixed later point in time.

Early responses received by the system controller 200 are processed by the main early response handler 210. As will be described in more detail below, the main early response handler 210 waits a period of time after receiving the early response indicator from the memory storage unit 104. After waiting this period of time, the main early response handler 210 initiates an arbitration request to the bus 202 in anticipation of later receiving the data pertaining to the request from the memory storage unit 104. In one embodiment, the arbitration request is initiated when there are no outstanding snoop commands, as described in more detail below. The main early response handler 210 may set a timer to wait for a period of time. In one embodiment, timers 214 are programmable timers whose predetermined values (to provide corresponding predetermined wait periods) are dependent on one or more configuration parameters or considerations of the system. For example, the value of one programmable timer for a predetermined wait period may be based, at least in part, upon predetermined knowledge of latency of data retrieval from the memory storage unit 104. The latency may relate to an amount of time that is needed to process the request for data within the memory storage unit 104 and retrieve the requested data from memory. In one embodiment, the timers 214 are hardware timers having values stored in memory-mapped registers that are accessible to the system controller 200 and programmed by the processor 204. In one embodiment, the processor 204 may evaluate the speed of various interfaces and the number of memory storage units 104 (and associated memory modules) when programming the values of timers. Examples of timer values will be provided in more detail below.

As described in reference to FIG. 1B, the requested data may currently be controlled by a different processing module 102. In this case, the processing module (e.g., snooped processing module 102B of FIG. 1B), may provide an early response indicator to the requesting processing module 102A. Therefore, the early response handlers 208 include a snoop early response handler 212 to handle such incoming early response indicators from snooped nodes. The snoop early response handler 212 also has access to the timer values stored in the storage area 214. In certain cases, the snoop early response handler 212 will initiate an arbitration request for use of the bus 202 upon receipt of the early response from the snooped node 102B, thereby forgoing the use of a timer. Examples of scenarios such that this will be described in more detail below.

The system controller 200 of a snooped node processing module 102B may receive a snoop command from a memory storage unit 104 that has received a read request from a separate, requesting processing module 102A. In this scenario, the memory storage unit 104 has determined that the processing module 102B may have a newer version of the requested data. Therefore, the system controller 200 shall, in one embodiment, process such incoming snoop commands with its snoop command handler 226. Upon receipt of a snoop command, the snoop command handler 226 will issue an early response directly to the system controller 200 of the requesting processing module 102A if the processing module 102B determines that it does have a local copy of the requested data. The snoop command handler 226 then retrieves the requested data from a local storage area of the snooped node 102B, such as from a local cache 206. Upon retrieval of the requested data, the snoop command handler 226 sends the data via a data response transaction to the system controller 200 of the requesting processing module 102A.

As shown in FIG. 2B, the system controller 200 further includes data response handlers 216. These handlers 216 include a main data response handler 218 and a snoop data response handler 220. The main data response handler 218 handles incoming data response transactions received from a memory storage unit 104, while the snoop data response handler 220 handles incoming data response transactions received from a snooped node 102B. Once data is received, the handler 218 or 220 is able to forward the received data to the processor 204 via the bus 202 in a new transaction. As discussed previously, the handler 218 or 220 access the transaction ID's within the storage area 222 to provide the transaction ID of the original request within the new response transaction that is sent back to the processor 204. In this fashion, the processor 204 can match the response transaction with its original read request transaction.

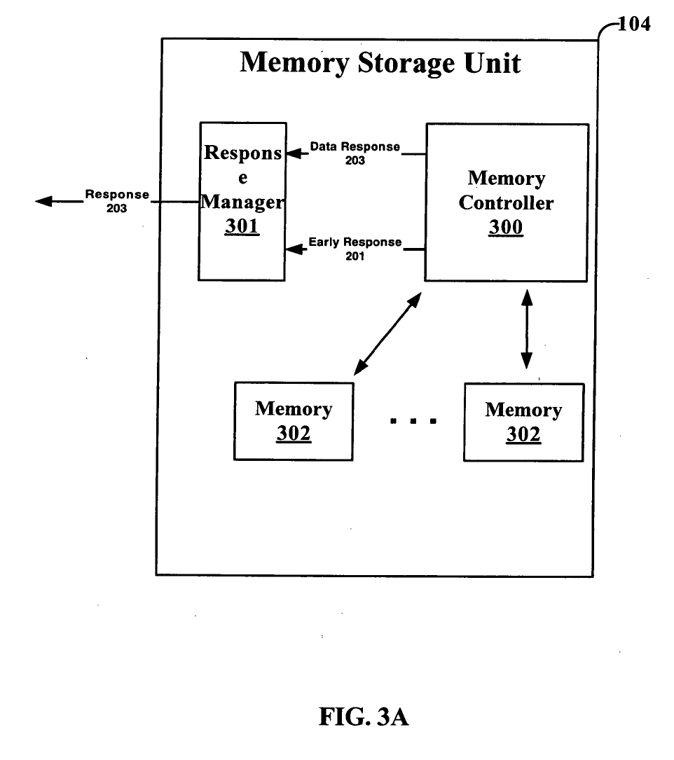

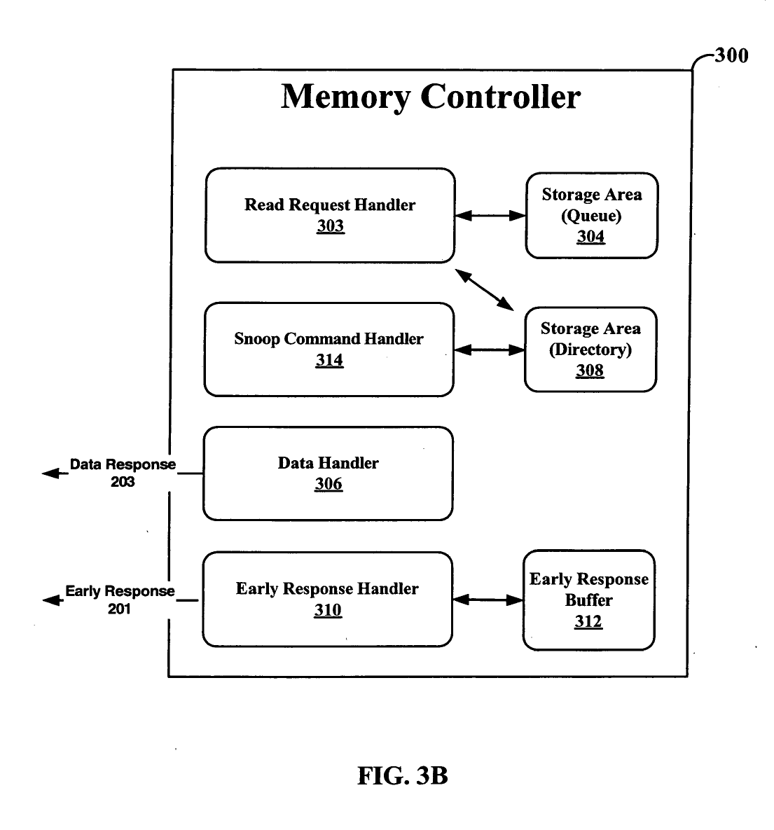

FIG. 3A is a block diagram illustrating additional details of an example memory storage unit 104, according to one embodiment. The memory storage unit 104 includes a memory controller 300 and memory 302. In one embodiment, the memory 302 comprises DRAM (dynamic random access memory). Various memory 302 units or chips may be included within the memory storage unit 104. In other embodiments, other forms of memory may be used. As is shown in FIG. 3A, the memory controller 300 controls access to and processing of data from memory 302. For example, when the memory controller 300 receives a read request from an external device, such as a processing module 102, it processes the request and retrieves the requested data from memory 302. When the memory controller 300 receives a write request and data, it processes the request and writes the data to memory 302.

As is shown in FIG. 3A, the memory controller 300 is capable of sending an early response 201 back to the system controller 200 of a processing module 102 after receiving a read request from the system controller 200. In one embodiment, the memory controller 300 may send the early response 201 at substantially the same time that it sends a read command to memory 302. Upon receipt of the early response 201, the system controller 200 may then use the early response 201 to determine when to both initiate arbitration of the processor bus and also subsequent phases on the bus in anticipation of the requested data arriving at a later time from the memory controller 300. By doing so, the system controller 200 need not wait for the data response 203 before initiating arbitration of the bus and subsequent phases on the bus. When the memory controller 300 receives the requested data from memory 302, it sends the data in the data response 203 back to the system controller 200. The system controller 200 may then stream the data to processor 204 via the bus 202 without further delay.

In the embodiment shown in FIG. 3A, the early response 201 and the data response 203 may be routed to the system controller 200 by way of a response manager 301. The response manager 301 manages the responses that are sent back to the system controller 200. A response 305 that is sent by the memory storage unit 104 to the system controller 200 may be either an early response 201 or a data response 203. In one embodiment, data responses, in general, take higher priority for processing than early responses. Thus, in this embodiment, if the response manager 301 receives both the early response 201 and the data response 203 at substantially the same time, the response manager 301 will first process the data response 203 as the response 305 that is sent back to the system controller 200. Subsequently, if there are no new incoming data responses, the response manager 301 will process the early response 201 as the next response 305 to send to the system controller 200. If a sequence of data responses need to be processed by the response manager 301, it is possible, in some cases, that the response manger 301 will need to buffer, or store, one or more early responses before they are sent. In one embodiment, the response manger 301 utilizes a timer to determine whether to process any such buffered early responses. If the timer expires for a given early response, the early response will be discarded, rather than sent to the system controller 200. This may occur when the memory controller 300 processes a high volume of data responses, in which case the early responses may lose their priority within the buffer. An early response is discarded when the corresponding early response timer has expired. In one embodiment, the length of such a timer is determined based upon an amount of time that is typically taken to process a data response for a given memory request within the memory storage unit 104.

FIG. 3B is a block diagram illustrating a portion of the memory controller 300 shown in FIG. 3A, according to one embodiment. As shown, the memory controller 300 includes a set of functional units and also storage areas. The functional units include the read request handler 303, the data handler 306, the early response handler 310, and the snoop command handler 314. The storage areas include the queue 304, the directory 308, and the early response buffer 312.

The read request handler 303 handles incoming read requests from a system controller 200 of a requesting processing module 102. In certain cases, the read request handler 303 may process the requests immediately, as they arrive. However, because the memory controller 300 may be coupled to various different processing modules 102, it may receive too many read requests to process simultaneously. As a result, the read request handler 303 may need to store requests within the storage area 304 for processing. The storage area 304 shown in FIG. 3B is a queue, although, in other embodiments, other forms of storage areas may be used. Once a given read request has been granted, or gained, priority out of the queue 304, the read request handler 303 may determine if a memory 302 contains the latest version of requested data. The read request handler 303 may also access a directory 308, according to one embodiment.

In one embodiment, the read request handler 303 uses the address of the read request to determine which memory 302 contains the requested data. After identifying the appropriate memory 302 (which may comprise, in one embodiment, dynamic random access memory (DRAM)), the read request handler 303 sends a read command to the memory 302. In certain cases, when a data processing system 100B includes a snooped node, such as the module 102B in FIG. 1B, the directory 308 may indicate that the processing module (snooped node) 102B has a version of the requested data. In one embodiment, the memory controller 300 is able to determine if the snooped node 102B has the most recent, or up-to-date, version of the data. In another embodiment, the memory controller 300 is unable to make such a determination. In either case, the memory controller 300 uses its snoop command handler 314 to send a snoop command to the snooped node 102B. Once the snooped node 102B receives the snoop command, it can retrieve the requested data from a storage area (such as its cache), and return the data either to the memory controller 300 or directly to the requesting processing module 102.

When the read request handler 303 sends the read command to the memory 302, the early response handler 310 may send an early response back to the requesting processing module 102 as a positive indication that memory controller 300 will provide the data at a future point in time. In one embodiment, the early response handler 310 sends the early response back to the system controller 200 of requesting processing module 102 at substantially the same time that the read request handler 303 sends the read command to memory 302. In one embodiment, the early response handler 310 sends the early response back to the system controller 200 of requesting processing module 102 after the read request handler 303 sends the read command to memory 302. In this embodiment, the early response handler 310 may place the early response in the buffer 312 for later processing, as is described in more detail below. Various examples using such early responses in different scenarios are described in more detail below with reference to the corresponding flow diagrams. An early response provides the requesting processing module with an early indicator that data will be forthcoming at a later point in time. If the snoop command handler 314 has sent one or more snoop commands to snooped nodes 102, the early response handler 310 includes information within the early response specifying the number of snoop commands that were issued.

It should be noted that, in some cases, the early response handler 310 may not send an early response to the requesting processing module 102 under certain conditions, according to one embodiment. Typically, early responses are issued substantially at the same time or shortly after issuance of read command or snoop commands. However, because a given memory controller 300 may need to process requests from multiple different processing modules 102, the early response handler 310 may need to produce multiple data responses that will delay the pending early responses. These multiple early responses are temporarily queued within a storage area 312, which is shown in FIG. 3B to be a buffer (although other forms of storage areas may also be used). Transactions within a memory storage unit 104 may be prioritized such that data reads and/or writes that contain actual data have priority over the processing of early responses. In the case where a read request from memory has been satisfied before a corresponding early response has been sent out, there would be no need to issue the early response. Instead, the data handler 306 would simply return the requested data to the processing module 102. In this case, the early response would not be issued, and it could be discarded from the early response buffer 312. If, however, the early response handler 310 gains priority for the early response before data has been read from memory 302, the handler 310 can remove the early response from the buffer 312 and send it to the processing module 102.

In one embodiment, the early response handler 310 may utilize a programmable, early response timer to determine whether to process or discard early responses stored in the buffer 312. The memory controller 300 may program the timer based upon predetermined knowledge of memory access time, latencies, priority processing of transactions, or other criteria. The early response handler 310 starts the timer for a given early response once it places the response in the buffer 312. If the timer expires, according to one embodiment, the early response handler 310 will discard the early response and remove it from the buffer 312 (such that the early response is not sent to the processing module 102). This discarding of the early response occurs because it has remained in buffer 312 for a defined period, during which time the actual data response may have already been processed. If, however, the early response obtains priority out of buffer 312 before the early response timer expires, the early response is sent to the processing module 102. In one embodiment, the response manager 301 shown in FIG. 3A may determine whether or not to discard early responses, rather than the early response handler 310. In this embodiment, the response manager 301 may utilize the programmable, early response timer to determine whether to process or discard early responses provided by the early response handler 310.

As noted, the data handler 306 of the memory controller 300 is responsible for sending data responses to the requesting processing module 102. When the data handler 306 receives data from memory 302, it then forwards the data in a data response to the requesting processing module 102.

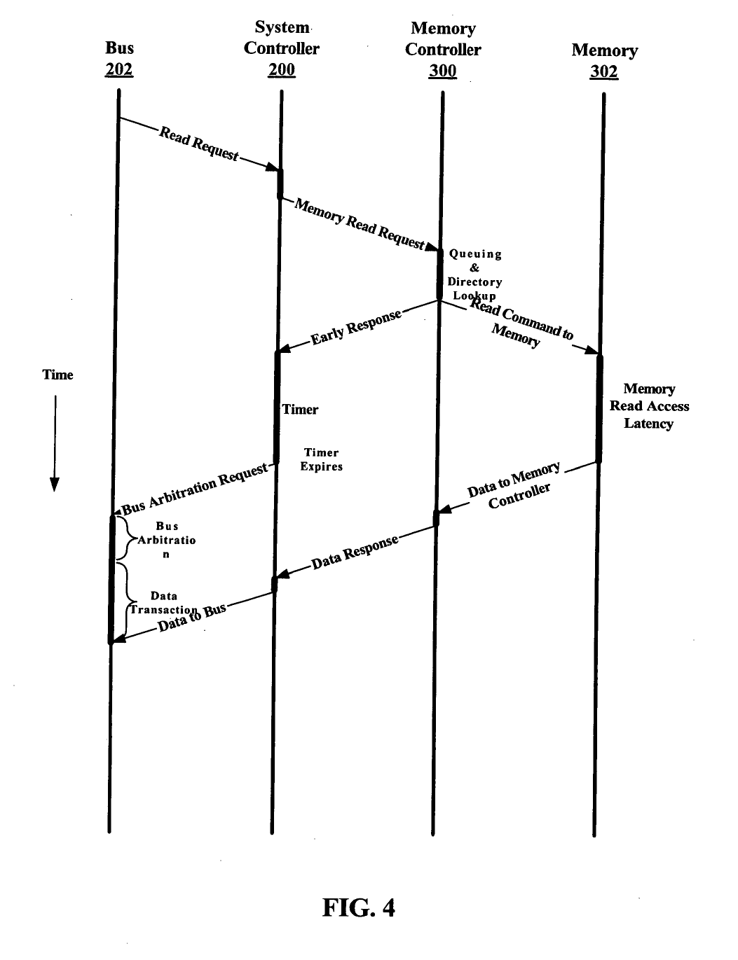

FIG. 4 is a flow diagram illustrating the processing of a read request sent by a system controller 200 to a memory controller 300, according to one embodiment. It is to be understood that various functional units, such as those exemplified in FIG. 2B and FIG. 3B, may be utilized to implement various functions of the system controller 200 and/or the memory controller 300 shown in FIG. 4 (and subsequent figures showing flow diagrams). It may also be understood that the system controller 200 (associated with the processing module 102) and the memory controller 300 (associated with the memory storage unit 104) communicate via the system interconnect 106 shown in FIG. 1A.

After the processor 204 within a processing module 102 determines a need to read data from memory, it issues a memory read request transaction to the system controller 200 via the bus 202. The system controller 200 receives the read request from the bus 202. As shown in the various flow diagrams, messages, such as requests and responses, are sent from one entity to another. In general, these messages may be referred to as transactions. Each transaction may comprise a multi-bit packet of information, as described previously, with a pre-defined format, according to one embodiment. The sending entity populates the transaction packet with information, and the receiving entity processes the transaction by reading data from the packet.

The system controller 200 analyzes the received request (such as a transaction packet) to determine which memory storage unit 104 contains the requested data. It may do so by, in one embodiment, analyzing the data address that is specified in the read request. The system controller 200 then sends the memory read request to the memory controller 300 of the appropriate memory storage unit 104. Through this process, the processor 204 effectively sends a read request to the memory controller 300 via the bus 202 and the system controller 200.

Upon receipt of the read request, the memory controller 300 will then, in one embodiment, place the read request in a queue for processing, such as the queue 304 shown in FIG. 3B. The memory controller 300 processes the read request from the queue 304 when it is able to do so and the interface to the memory is available. In other embodiments, the memory controller 300 may process incoming read requests as soon as they are received from the system controller 200, or may temporarily store the requests in storage areas other than the queue 304.

When processing a read request, the memory controller 300 may access a directory, such as the directory 308 shown in FIG. 3B, to determine if the snoop requests need to be sent to nodes that have ownership or copies of the read data. The memory controller 300 also initiates a read command to the memory 302 based on the mapping of the requested address. In one embodiment, the memory 302 comprises dynamic random access memory (DRAM) within a dual in-line memory module (DIMM).

Typically, there is a well known, or fixed, memory read access latency when retrieving data from the memory 302, due to access and interface timing. For example, when the memory 302 comprises DRAM, and when a 2.5 nanosecond clock is being utilized, it may take approximately thirty cycles to access data from the memory 302. This memory read access latency is represented by the bold vertical line (for the memory 302) shown in FIG. 4.

In one embodiment, the memory controller may perform a directory lookup and determine that the most up-to-date version of the requested data is within memory 302. In this embodiment, the memory controller 300 sends a read command to the memory 302 after the read request transaction has gained priority by the memory controller 300. However, in addition to sending the read command to the memory 302, the memory controller 300 also sends the early response indicator (transaction) back to the system controller 200 so as to provide a positive indication that location for the data has been identified and that the data will be forthcoming at a later, or subsequent, point in time. The memory controller 300 sends the early response substantially concurrently with, sending the read command to the memory 302, according to one embodiment. The system controller 200 can utilize the early response as a reference point in time from which to initiate bus arbitration prior to receiving the actual data.

As noted earlier, there typically is a fixed latency for memory read access from the memory 302, due to access and interface timing. This fixed latency determines, in one embodiment, the relative delay between the early response and the data response being received by the system controller 200. This provides the system controller 200 with a positive, predictable mechanism to trigger the logic to arbitrate for the processor bus 202.

In one embodiment, the system controller 200 uses the receipt of the early response to initiate the arbitration of the bus 202. The optimum time for this early arbitration may be a determined number of bus cycles before the data arrives from the memory controller 300 and is to be transmitted onto the bus 202. But, the time between the receipt of the early response by the system controller 200 and receipt of the data response, determined by the relatively fixed latency of the memory access of the memory 302, is typically greater than this determined number of bus cycles for arbitration of the bus 202. If arbitration to the bus 202 is performed too early, the system controller 200 would have ownership of the bus 202 but may potentially need to invoke a data stall on the bus 202, as it would not yet have received the data response. To address this issue, a programmable timer may be implemented and utilized by the system controller 200, as described in some detail earlier, that will delay the initiation of arbitration until a determined number of bus cycles before the data response is expected. This timer is initiated when the system controller 200 receives the early response from the memory controller 300, and when the timer expires, the system controller 200 triggers arbitration of the bus 202. After the arbitration and subsequent phases on the bus 202, the system controller 200 can route the data to the bus 202 at the appropriate bus cycle without further delay. The overall result, in one embodiment, is that the data latency due to the memory access effectively hides the arbitration and required cycle delay on the bus 202.

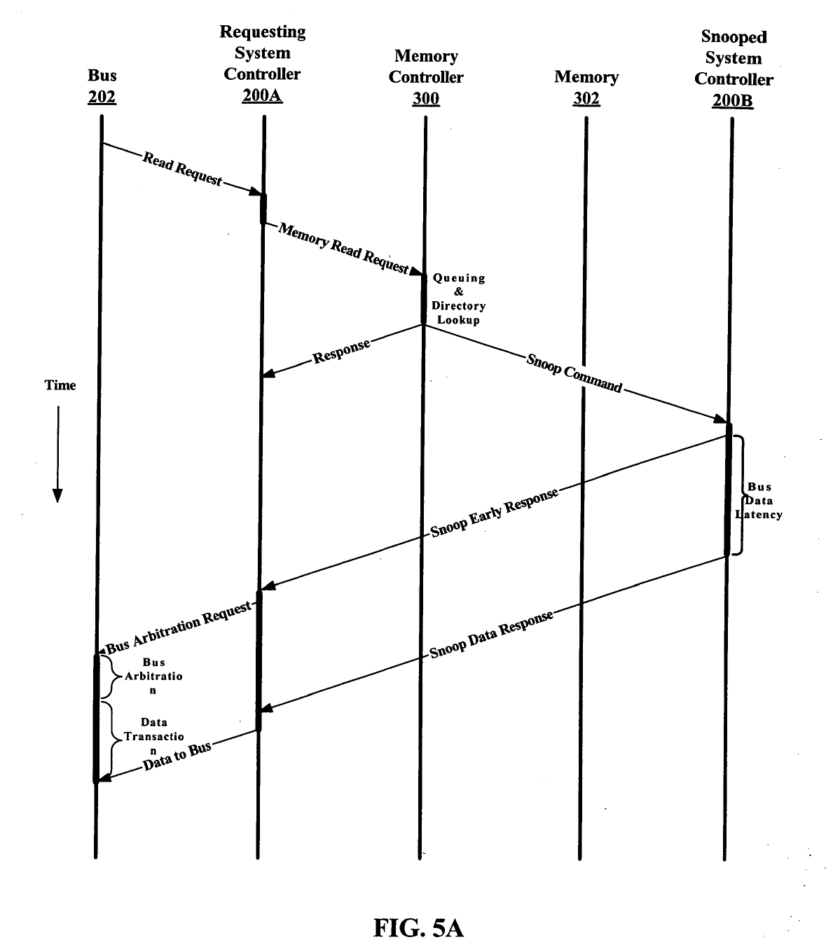

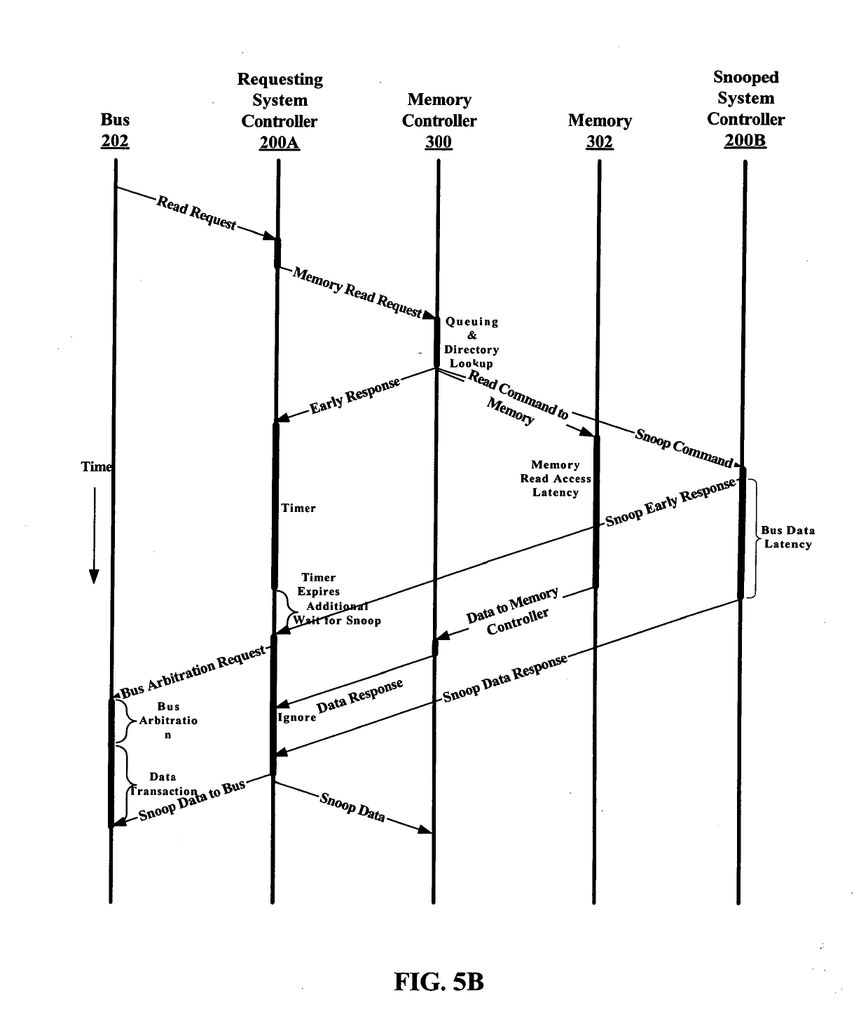

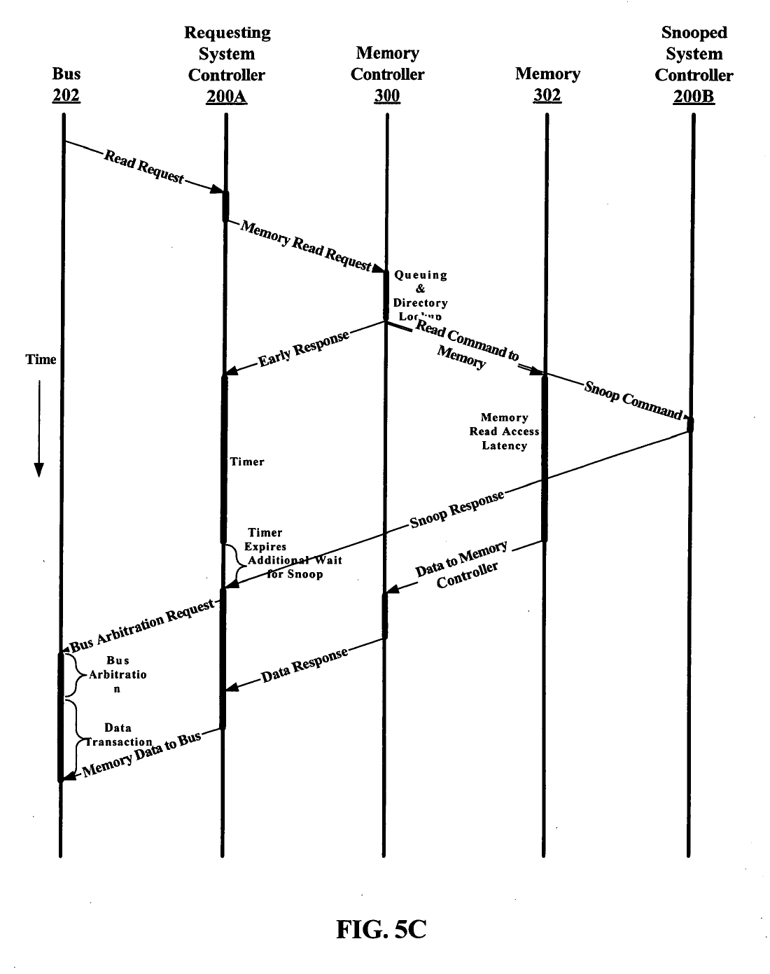

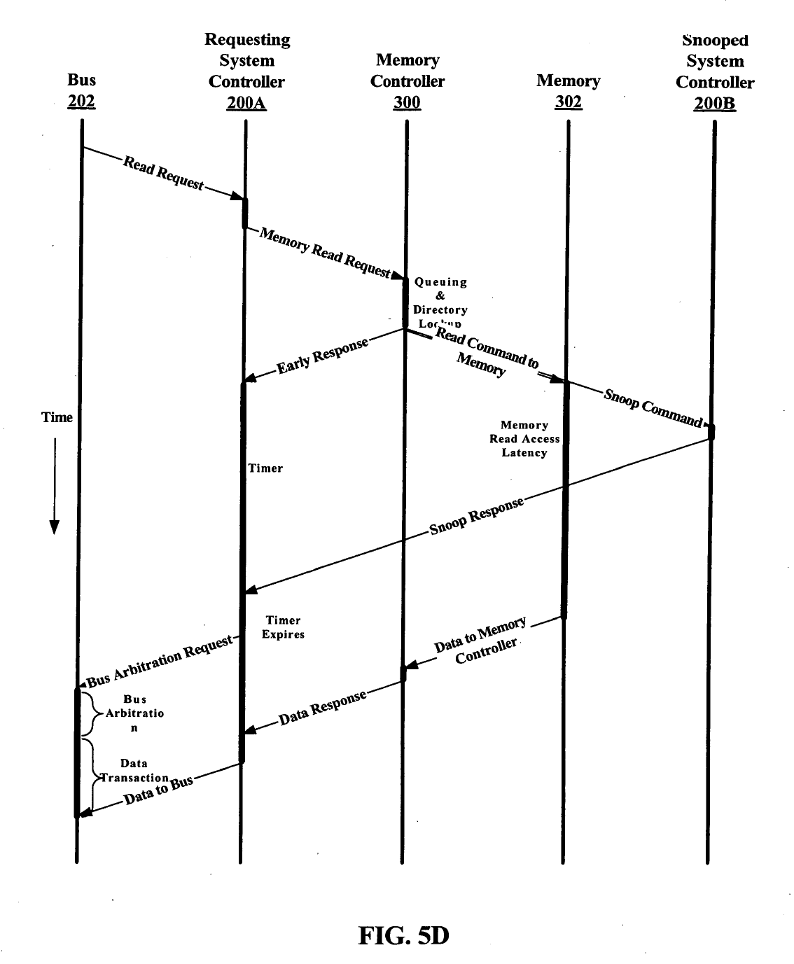

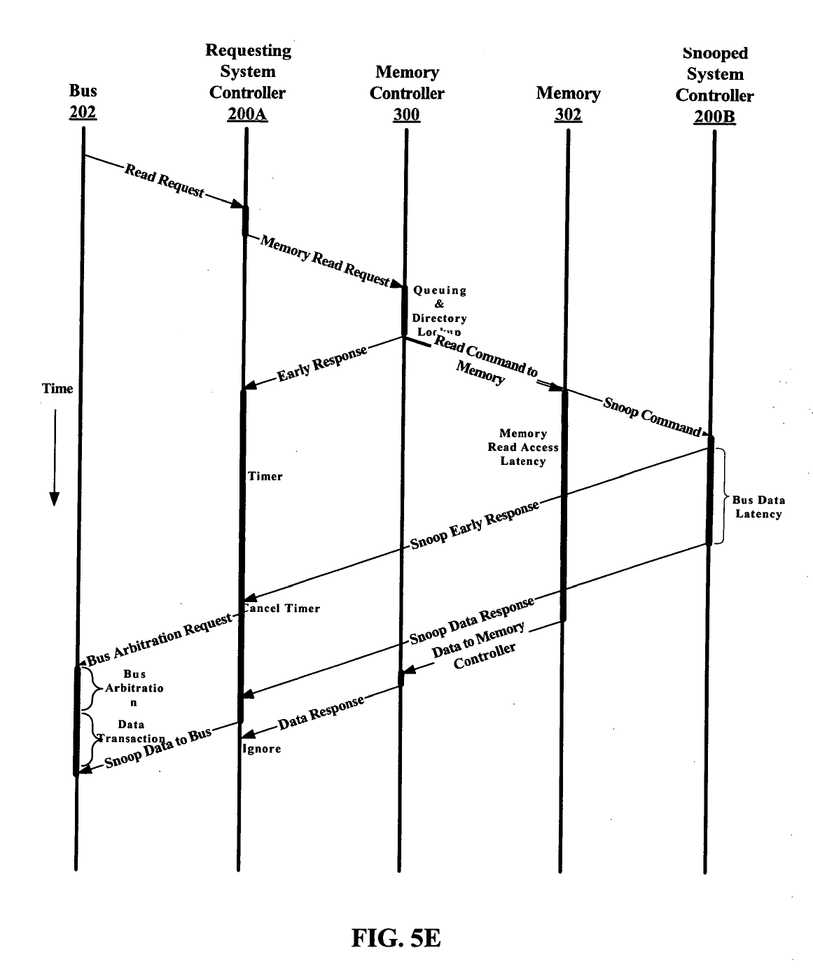

In one embodiment, the timer used by the system controller 200 is a programmable timer, as was discussed previously. The system controller 200 may obtain the timer value from the storage area 214, shown in FIG. 2B. In one embodiment, the timer value may be strategically chosen to substantially match the amount of time it takes to obtain requested data from the memory 302 (shown as the memory read access latency in FIG. 5). By doing so, the system controller 200 can wait a known period of time before initiating the bus arbitration request. The timer value stored within the storage area 214 may be programmed or changed if various parameters or configuration settings change within the system, such that the bus arbitration request is sent to the bus 202 at the optimum time. It is desirable for the system controller 200 to send data from a data response directly to the bus 202 as soon as it receives the data response from the memory controller 300, according to one embodiment. By doing so, the system controller 200 need not buffer or store the data for a period of time before sending it to the bus 202.

FIG. 5A-5E are flow diagrams illustrating various embodiments of the processing of read requests sent by the system controller 200A to a memory controller 300, wherein the memory controller 300 additionally sends a snoop command to a snooped system controller 200B. As shown in the example of FIG. 1B, a system 100B may include both a processing module 102A and a snooped node 102B. The processing module 102A may comprise a requesting module 102A that includes a requesting system controller 200A. The snooped node 102B includes a snooped system controller 200B. Both the requesting system controller 200A and the snooped system controller 200B are shown in FIG. 5A-5E.

Referring first to FIG. 5A, the flow diagram shows a first example in which the requesting system controller 200A receives a read request from the bus 202, and sends a memory read request to the memory controller 300. After the read request gains priority out of the queue, the memory controller 300 utilizes a directory 308 to determine where the copies of the requested data are stored. In this particular example, the memory controller 300 positively identifies a location of the requested data by determining that the most recent, or up-to-date, version of the data is stored in the snooped node 102B. Therefore, rather than sending a read command to the memory 302, the memory controller 300 instead sends a snoop command directly to the snooped system controller 200B of the snooped node 102B. The memory controller 300 also sends a response to the requesting system controller 200A as a positive indication that the location of the requested data has been identified. The memory controller 300 sends the response either substantially concurrently with, or after, sending the snoop command, according to one embodiment.

Within the response, the memory controller 300 includes information indicating that it has sent a snoop command to a snooped system controller 200B. (If the memory controller 300 determines that multiple snooped nodes 102B may have copies of the requested data, it may send snoop commands to each of these snooped nodes 102B. In this case, the memory controller 300 includes information in the response to specify the number of different snooped commands that it has issued.) In one embodiment, the response may further indicate that no data will be arriving from the memory 302 or the memory controller 300, but that such requested data will be arriving from the snooped system controller 200B. In one embodiment, the requesting system controller 200A, upon receipt of the response, it will parse the response to identify the number of snooped commands that had been sent out by the memory controller 300, and will wait for a period of time until it has received a corresponding number of snoop responses from the associated snooped system controllers 200B. In one embodiment, the memory controller 300 sends only one snoop command to a snooped system controller 200B after it has determined that the snooped system controller 200B is associated with a snooped node 102B that has a modified version of the data.

The snooped system controller 200B returns a snoop early response back to the requesting system controller 200A after the snooped system controller 200B finds modified data on its processor bus, such as in a local storage area (e.g., cache). There is an inherent amount of latency in the bus protocol that delays the data being returned to the requesting system controller 200A. This fixed latency determines the relative delay between the early response and the data response being received by the requesting system controller 200A from the snooped system controller 200B. This provides the requesting system controller 200A a positive predictable mechanism to trigger the logic that will arbitrate for the bus and return the data to the processor via the bus 202. The data latency, however, on the bus for the snooped node 102B (with the snooped system controller 200B) is typically much shorter than the data latency from memory access on a memory storage unit 104. As a result, the requesting system controller 200 typically does not need to implement an additional timer after it has received the snoop early response. Instead, the requesting system controller 200 may initiate the bus arbitration request to the bus 202 after it has received the snoop early response from the snooped system controller 200. Once the bus has processed the arbitration request and subsequent phases for the data transaction, the requesting system controller 200 shall most likely have received the snoop data response from the snooped system controller 200. As such, the requesting system controller 200A can then send the data to the bus 202 without further delay, and without having to temporarily store the data in a buffer while waiting for the bus.

Referring to FIG. 5B, another exemplary flow diagram is shown for another scenario in which the memory controller 300 sends a response back to the requesting system controller 200A and a snoop command to the snooped system controller 200B. In this scenario, the memory controller 300 has determined that the snooped node 102B has a version of the requested data, and therefore sends the snooped command to the snooped system controller 200B. However, the memory controller 300 may not be certain whether the memory 302 or the snooped node 102B has the most current, or up-to-date, version of the data. For this reason, the memory controller 300 also sends a read command to the memory 302. It sends this read command at substantially the same time as it sends the snoop command, according to one embodiment. The memory controller 300 sends the response to the requesting system controller 200A at substantially the same time, or after, sending the memory read commands.

Within the response message (transaction), the memory controller 300 includes information indicating that it has sent both a read command to the memory 302 and a snoop command to the snooped system controller 200B. When the requesting system controller 200A receives and parses the response, it determines that the memory controller 300 has sent a read command to the memory 302, and therefore starts the timer. In one embodiment, the requesting system controller 200A starts and uses the timer when the memory controller 300 has sent a read command to the memory 302, due the memory read access latency of the memory retrieval process.

As shown in the example of FIG. 5B, however, the timer expires before the requesting system controller 200A has received additional information, such as the snoop response or snoop early response. Because the requesting system controller 200A knows, though, that the memory controller 300 sent a snoop command to the snooped system controller 200B, the requesting system controller 200A waits additional time to receive the snoop response from the snooped system controller 200B. In one embodiment, the snoop response can be an early snoop/data response, or a response indicating that no snoop data is being sent. The requesting system controller 200A waits this additional period of time because, in one embodiment, the requesting system controller 200A is not yet sure whether the most recent, or up-to-date, version of the requested data will arrive from the memory controller 300 or the snooped system controller 200B. The snooped system controller 200B includes information within the snoop early response, according to one embodiment, to indicate whether it has modified data. FIG. 5B shows an example of a scenario in which the snooped system controller 200B will provide a more recent, or up-to-date, version of the data.

When the requesting system controller 200A receives the snoop early response, it parses the response to determine that it will later be receiving data from the snooped system controller 200B. It then sends the bus arbitration request to the bus 202. At a later point, the requesting system controller 200A will receive a data response from the memory controller 300. Because, however, the snoop early response indicated that modified data will be arriving from the snooped node 102B, the requesting system controller 200A may ignore, or discard, the data response from the memory controller 300. Once it receives the snoop data response from the snooped system controller 200B, it may send the snoop data to the bus 202. In one embodiment, it may immediately send this data to the bus 202 without needing to buffer the data while waiting for the bus. In one embodiment, after the requesting system controller 200A has received the snoop data response from the snooped system controller 200B, it may then send a copy of the snoop data to update the memory controller 300.

FIG. 5B shows the requesting system controller 200A receiving the data response from the memory controller 300 prior to receiving the snoop data response from the snooped system controller 200B. However, in other scenarios, depending on the overall timing and latencies in the system, the requesting system controller 200A may receive the data response from the memory controller 300 after, or substantially at the same time as, receiving the snoop data response.

FIG. 5C is a flow diagram of another exemplary scenario in which the memory controller 300 sends a read command to the memory 302, a snoop command to the snooped system controller 200, and an early response to the requesting system controller 200A, similar to the example of FIG. 5B. Unlike the example of FIG. 5B, however, the snooped node 102B does not have modified data. In this case, the snoop response indicates that the snooped node 102B does not have modified data. Therefore, the requesting system controller 200A, upon receipt and parsing of the snoop response, knows that it need not wait for data from the snooped system controller 200B, and that the data to process will be that contained in the data response from memory. As a result, the requesting system controller 200A still sends the bus arbitration request to the bus 202 after it receives the snoop response, but is able to send the data to the bus 202 after it has received the data response from the memory controller 300.

FIG. 5D is a flow diagram that illustrates another exemplary scenario. This scenario is quite similar to the one shown in the diagram of FIG. 5C, wherein the snooped node 102B does not have modified data, and wherein the requesting system controller 200A sends data received from the memory controller 300 to the bus 202. However, in the example shown in FIG. 5C, the timer used by the requesting system controller 200A expires before the snoop response arrives from the snooped system controller 200B. In that scenario, the requesting system controller 200A needed to wait an additional period of time to receive the snoop response before issuing the bus arbitration request. In the exemplary scenario shown in FIG. 5D, however, the requesting system controller 200A receives the snoop response from the snooped system controller 200B before the timer expires. Once the requesting system controller 200A receives and parses the snoop response, it determines that the snooped node 102B does not have modified data, and that it need not expect any response data from the snooped system controller 200B. In this case, the requesting system controller 200A allows the timer to continue running until it expires, due to the fact that it will wait for and process data from the memory controller 300.

Once the timer expires, the requesting system controller 200A sends the bus arbitration request to the bus 202, to initiate the bus arbitration and data transaction phases of the bus. When the requesting system controller 200A receives the data response from the memory controller 300, it sends the data to the bus 202 without delay, according to one embodiment.

FIG. 5E is a flow diagram of another, final exemplary scenario. This scenario is similar to the one shown in the flow diagram of FIG. 5D. However, in the example of FIG. 5E, the snooped node 102B contains modified data. Therefore, the snooped system controller 200B includes information in the snoop early response to indicate that the snooped node 102B has modified data. When the requesting system controller 200A receives and parses the snoop early response, it determines that the snooped node 102B has modified data, and therefore cancels the timer, rather than letting the timer run through expiration. After cancelling the timer, the requesting system controller 200A sends the bus arbitration request to the bus 202. When the requesting system controller 200A receives the snoop data response, it can send the snoop data to the bus 202 without further delay, according to one embodiment. Although the requesting system controller 200A may still receive a data response from the memory controller 300, it will ignore or discard this data, because it knows that the most recent, or up-to-date, version of the data has come from the snooped system controller 200B.

Various embodiments of the invention have been described. These and other embodiments are within the scope of the following claims.

1. A method comprising: sending a request for data from a controller to a memory storage unit, the controller being associated with a processor, the processor and the associated controller comprising a processing module; receiving, by the controller, an early response from the memory storage unit indicating that the controller will later receive the requested data; sending a snoop command from the memory controller to a controller of a snooped processing module if the memory controller determines that the snooped processing module has a version of the requested data sending the early response from the memory controller to the controller associated with the processor, the early response specifying that the memory controller has sent the snoop command; upon receipt of the early response indicator, starting a timer with the controller to wait a period of time; and after expiration of the timer but prior to receipt of the requested data, sending an arbitration request from the controller to initiate a transaction on a bus to communicate the requested data from the controller to the processor when the requested data is later received by the controller.

2. The method of claim 1, further comprising: receiving, by the controller, the requested data; and sending the received data to the processor across the bus.

3. The method of claim 1, further comprising: sending the early response from the memory storage unit to the controller; sending a read command from the memory storage unit to memory for the requested data; after sending the early response and the read command, receiving the requested data from memory; and sending the received data from the memory storage unit to the controller.

4. The method of claim 1, wherein starting the timer comprises:
starting a hardware timer set for a predetermined wait period; and waiting for the hardware timer to expire.

5. The method of claim 4, wherein the predetermined wait period is based, at least in part, on predetermined knowledge of latency of data retrieval from the memory storage unit.

6. The method of claim 1 wherein sending the request for data from the processor to the memory storage unit comprises sending the request from the controller to a memory controller of the memory storage unit.

7. (canceled)

8. The method of claim 1, further comprising: receiving, from the snooped processing module, a snoop early response indicating that the controller associated with the processor will later receive, from the snooped processing module, the requested data.

9. The method of claim 8, further comprising: receiving the requested data from the snooped processing module; and sending the received data to the processor across the bus.

10. The method of claim 8, wherein starting the timer to wait the period of time comprises waiting for the snoop early response from the snooped processing module, and wherein sending the arbitration request occurs after receipt of the snoop early response.

11. A data processing system, comprising: a bus; a processor; and a controller associated with the processor, the processor and the associated controller comprising a processing module, the data processing system being configured to send a request for data to a memory storage unit, the memory storage unit comprising an early response handler which is configured to: send an early response to the controller, the early response indicating that the controller will later receive the requested data; send, the memory storage unit further comprising a read request handler to send a read command to memory for the requested data, a snoop command handler to send a snoop command to a snooped processing module upon determining that the snooped processing module has a version of the requested data, the early response handler specifying within the early response that the memory storage unit has sent the snoop command, and a data handler to send data to the controller after it is read from memory; wherein, upon receipt of the early response indicator, the data processing system starts a timer to wait a period of time; and after expiration of the timer but prior to receipt of the requested data, sends an arbitration request to initiate a transaction on the bus to communicate the requested data from the controller to the processor when the requested data is later received by the controller.

12. The system of claim 11, wherein the controller and associated processor are part of a processing module, and wherein the controller includes a read request handler to send the request to a memory controller of the memory storage unit.

13. The system of claim 11, wherein the controller includes an early response handler to start the timer for a predetermined wait period and to wait for the timer to expire.

14. The system of claim 13, wherein the predetermined wait period is based, at least in part, on predetermined knowledge of latency of data retrieval from the memory storage unit.

15. (canceled)

16. (canceled)

17. The system of claim 11, wherein the controller further includes: a snoop early response handler to receive, from the snooped processing module, a snoop early response indicating that the controller will later receive, from the snooped processing module, the requested data; and a snoop data response handler to receive the requested data from the snooped processing module.

18. The system of claim 11, further comprising the memory storage unit that includes an early response buffer for holding the early response prior to its being sent to the controller associated with the processor.

19. The system of claim 18, wherein the memory storage unit uses an early response timer to determine whether to send the early response to the controller.

20. A data processing system, comprising: means for sending a data request to a memory storage unit; means for processing an early response from the memory storage unit indicating that the requested data will arrive at a later time; means for waiting a period of time; and after waiting the period of time, means for sending an arbitration request to initiate a transaction on a bus in to communicate the requested data when it is later received
